(19) United States
(12) Patent Application Publication
(10) Pub. No.: US 2008/0023518 A1
(43) Pub. Date: Jan. 31, 2008

(54) Exhaust deflector for pneumatic power tool

(75) Inventor: Andrzej R. Wojcicki, Baltimore, MD (US)

Correspondence Address: HARNESS, DICKEY & PIERCE, P.L.C., P.O. BOX 828, BLOOMFIELD HILLS, MI, 48303, US

(73) Assignee: Black & Decker Inc.

(21) Appl. No.: 11/497,030

(22) Filed: Jul. 31, 2006

(51) Int. Cl. B25C 1/04

(52) U.S. Cl. 227/130

(57) ABSTRACT

A pneumatic fastening tool includes a housing having a fastening tool portion including a dispensing portion for dispensing a fastener. An exhaust assembly may be defined on a distal end of a handle portion. The exhaust assembly may include an end cap fixedly mounted to the housing and define a first annular engagement surface. A deflector may be rotatably mounted to the end cap and define a second annular engagement surface. The deflector may be configured to direct exhausted air from the tool in a plurality of user defined directions depending on the rotational orientation of the deflector. A friction member may be disposed between the first and second annular engagement surfaces. The friction member may provide a seal between the first and second annular engagement surfaces and permit rotation of the deflector relative to the end cap.

### FIELD

The present disclosure relates to pneumatic tools, and more particularly to an exhaust assembly for a pneumatic tool.

### BACKGROUND

Pneumatic air tools, such as nailers and staplers, are relatively commonplace in the construction trades. Many features of typical pneumatic tools, while adequate for their intended purpose, do not provide the user with a desired degree of flexibility and function. For example, it would be beneficial in some instances to direct the exhaust flow from a pneumatic tool in a desired direction. Accordingly, there remains a need in the art for an improved pneumatic tool.

### SUMMARY

A pneumatic fastening tool includes a housing having a dispensing portion for dispensing a fastener. The tool may further define a handle portion. An inlet may be configured to receive an input of compressed air. An exhaust assembly may be coupled to a distal end of the handle portion. The exhaust assembly may include an end cap fixedly mounted to the housing and define a first annular engagement surface. A deflector may be rotatably mounted to the end cap and define a second annular engagement surface. The deflector may be configured to direct exhausted air from the tool in a plurality of user defined directions depending on the rotational orientation of the deflector. A friction member may be disposed between the first and second annular engagement surfaces. The friction member may provide a seal between the first and second annular engagement surfaces while also permitting rotation of the deflector relative to the end cap.

According to additional features, the housing may define an air passageway configured to communicate air from the inlet, to the fastening tool portion and out of the tool through the exhaust assembly. The end cap may define an opening wherein air communicated through the exhaust assembly passes through the opening to the deflector. The deflector may define an air directing surface configured to direct air being passed from the opening of the end cap and through at least one outlet formed in the deflector.

According to other features, the air directing surface of the deflector may include a cylindrical air-deflecting wall portion offset radially inwardly relative to the first annular engagement surface of the end cap. The air directing surface of the deflector may additionally include a terminal wall portion extending generally transverse to the cylindrical wall portion and an intermediate radiused wall portion connecting the cylindrical wall portion and the terminal wall portion.

According to still other features, the deflector may include a first engagement tab. The deflector may be configured to rotate about the first annular engagement surface upon a user input force applied to the first engagement tab. The deflector may also include a second engagement tab. The first and second engagement tabs may each be defined along a distinct plane intersecting a longitudinal axis defined by the inlet. The outlet may include a first outlet formed adjacent to the first engagement tab and a second outlet formed adjacent to the second engagement tab. The first and second outlet passages may each define an opening configured to direct exhausted air in a direction parallel to the longitudinal axis. In one example, the friction member includes an o-ring. The exhaust assembly may include a retaining ring disposed in an annular groove formed on the end cap. The retaining ring may engage a retaining surface defined on the exhaust. The retaining ring may inhibit axial movement of the exhaust relative to the end cap.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a tool constructed in accordance to the present teachings;

FIG. 2 is a perspective view of the tool of FIG. 1 illustrating the exhaust assembly exploded from a remainder of the tool;

FIG. 3 is a sectional view taken along the line 3-3 of FIG. 1;

FIG. 4 is a rear perspective view of a portion of the tool of FIG. 1 illustrating an end cap and deflector of the exhaust assembly;

FIG. 5 is a rear perspective view of the end;

FIG. 6 is a rear perspective view of the deflector;

FIG. 7 is a front perspective view of the deflector;

FIG. 8 is a sectional view taken along the line 8-8 of FIG. 1; and

FIG. 9 is a sectional view taken along the line 9-9 of FIG. 4.

### DETAILED DESCRIPTION

The following description is merely exemplary in nature and is not intended to limit the present disclosure, application, or uses.

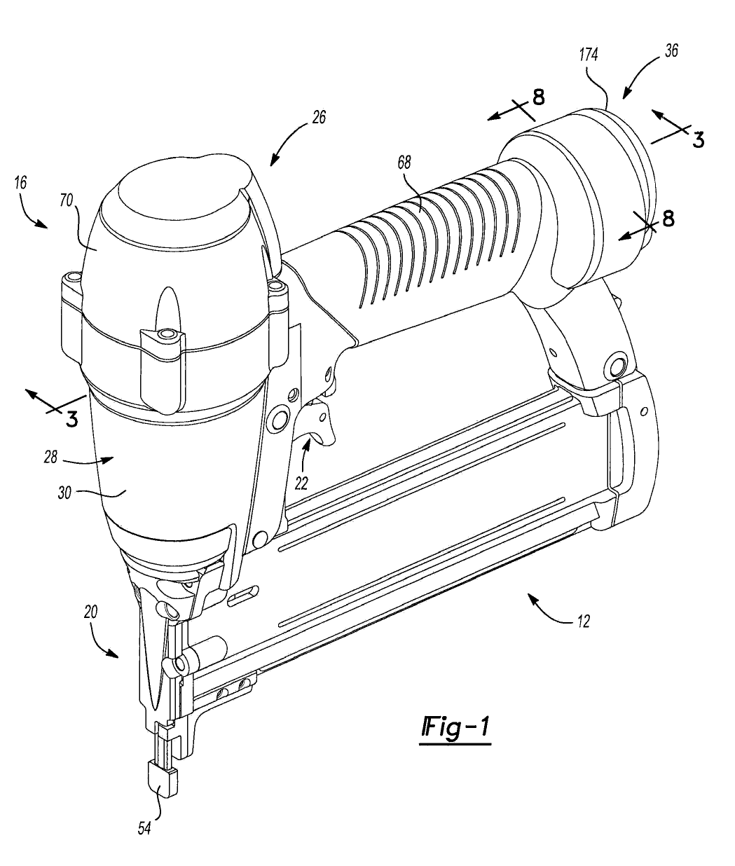

With initial reference to FIG. 1, a pneumatic fastening tool constructed in accordance to the present teachings is shown and generally identified at reference numeral 10. The fastening tool 10 can generally include a magazine assembly 12, and a fastening tool portion 16. The fastening tool portion 16 may include a nosepiece assembly 20, a trigger assembly 22, a cap assembly 26, an engine assembly 28, a housing 30 and an exhaust assembly 36.

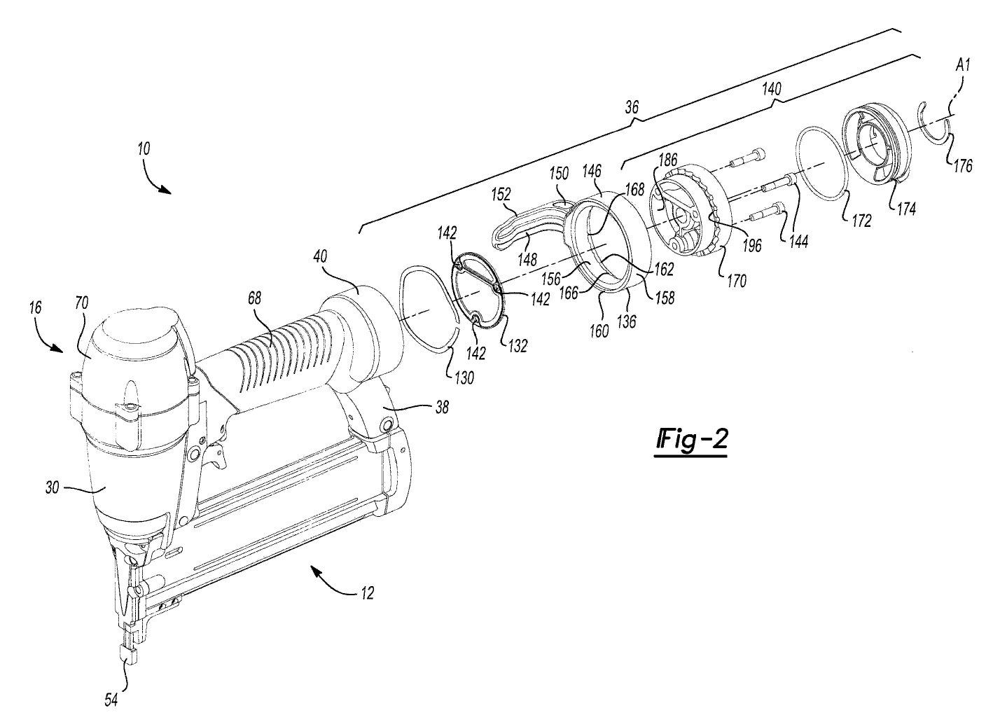

With reference to FIGS. 2 and 3, the magazine assembly 12 may extend between the nosepiece assembly 20 and a foot 38 formed at a distal end 40 of the housing 30. The magazine assembly 12 may include a magazine housing 42 having a pair of guide housing portions 44 and 46. A biasing member 48 may be disposed around a central rod 50. The biasing member 48 may be configured to sequentially urge fasteners (not shown) in a direction toward the nosepiece assembly 20 during operation. It is appreciated that the magazine assembly 12 is merely exemplary and other configurations may be employed.

The nosepiece assembly 20 may include a contact trip 54 slidably disposed along a nosepiece body 56. In one example, the contact trip 54 may be adjustable so as to permit the tool operator to vary the depth at which the tool 10 sets the fasteners. A trigger lever 58 may be operably coupled between the contact trip 54 and the trigger assembly 22 in a conventional manner that is well known in the art. The trigger assembly 22 may include a primary trigger 60, a secondary trigger 62 and a trigger valve 64 that selectively controls the flow of compressed air to the engine assembly 28. The primary trigger 60 may be pivotally mounted to the housing 30 and movable in response to the tool operator's finger. Movement of the primary trigger 60 will not, in and of itself, alter the state of the trigger valve 64. Rather, the trigger lever 58 must also move into contact with the secondary trigger 62 before the state of the trigger valve 64 is changed to permit compressed air to flow to the engine assembly 28. Other configurations may be used.

With specific reference now to FIG. 3, the housing 30 may generally define a handle portion 68, a cap portion 70 and an engine portion 72. The housing 30 defines an air passageway 74 having an intake portion 76, a working portion 78 and an exhaust portion 80. More specifically, the intake portion 76 is generally defined between a housing inlet 82 and the trigger valve 64. The working portion 78 is generally defined between the trigger valve 64, through the engine assembly 28 and to the cap assembly 26. The exhaust portion 80 is generally defined from the cap assembly 26 and to the exhaust assembly 36. As illustrated, the intake and exhaust portions 76 and 80, respectively, are each formed through the handle portion 68 of the housing.

The engine portion 72 of the housing 30 may be a container-like structure having a front base 86 and an outwardly tapering sidewall 88 that cooperate to form an engine cavity 90. The outwardly tapering sidewall 88 terminates at the cap assembly 26. The housing 30 may include a piston bumper 92 formed at the engine portion 72.

The cap assembly 26 may include a cap housing 96, an exhaust manifold 98 and a top bumper 100. The cap housing 96 may include an outer cap wall 102 that is generally flat at the rear of the tool 10, but folds over on its sides to form a cup-like container having a generally flat forward face that is configured to engage a housing seal 108. The housing seal 108 permits the cap housing 96 to be sealingly coupled to the rear of the tool housing 30. An annular cap exhaust port 110 directs exhaust into a connecting channel 112. The connecting channel 112 directs exhaust air into the exhaust portion 80 of the air passageway 74.

The engine assembly 28 may include a cylinder 120, a piston 122 and a rod or driver blade 124. In general, when the trigger assembly 22 is actuated to change the state of the trigger valve 64 to an actuated state, air pressure acts on the piston 122 to drive the piston 122 and the driver blade 124 in a direction downwardly as viewed from FIG. 3 so that a tip portion (not specifically shown) of the driver blade 124 drives a fastener (not shown) into a workpiece (not shown). When the state of the trigger valve 64 is changed to its unactuated state, compressed air is routed through the cap assembly 26, through the exhaust portion 80 of the air passageway 74 and to the exhaust assembly 36.

With reference to FIG. 2, the exhaust assembly 36 will be described in greater detail. The exhaust assembly 36 may include a wave spring 130, a gasket 132, a belt hook 136 and a deflector assembly 140. The wave spring 130 may be disposed between the housing 30 and the belt hook 136, while the gasket 132 can be disposed between the housing 30 and the deflector assembly 140. The gasket 132 may define openings 142 adapted to accept fasteners 144 as will be described.

The belt hook 136 can define a cylindrical body 146 and a hook portion 148. The hook portion 148 may include a foundation portion 150 and a finger portion 152. As shown, the foundation portion 150 can extend from the cylindrical body 146 and can transition into the finger portion 152. The finger portion 152 can extend substantially parallel to a longitudinal axis A₁ defined by the handle portion 68 of the tool 10. The cylindrical body 146 can include an inner radial surface 156 and an outer radial surface 158. The inner radial surface 156 can define first and second annular ledges 160 and 162, respectively. The first annular ledge 160 may be formed on an inboard side of the cylindrical body 146 and provides an annular pocket to accommodate the wave spring 130 (FIG. 3). The second annular ledge 162 may be formed on an outboard side of the cylindrical body 146. The second annular ledge 162 can define a first interlocking geometry 166. In the example shown, the first interlocking geometry 166 includes a wave-like wall 168. As can be appreciated, the hook portion 148 of the belt hook 136 allows a user to hook the finger portion 152 onto a support such as a user's belt when not in use.

The deflector assembly 140 can include an end cap 170, the fasteners 144, a friction member 172, an exhaust deflector 174 and a retaining ring 176. As will be appreciated from the following discussion, the exhaust deflector 174 is rotatable about the longitudinal axis A₁ of the handle portion 68 and is configured to direct exhaust air from the tool 10 in a plurality of user selected directions depending upon its rotational orientation.

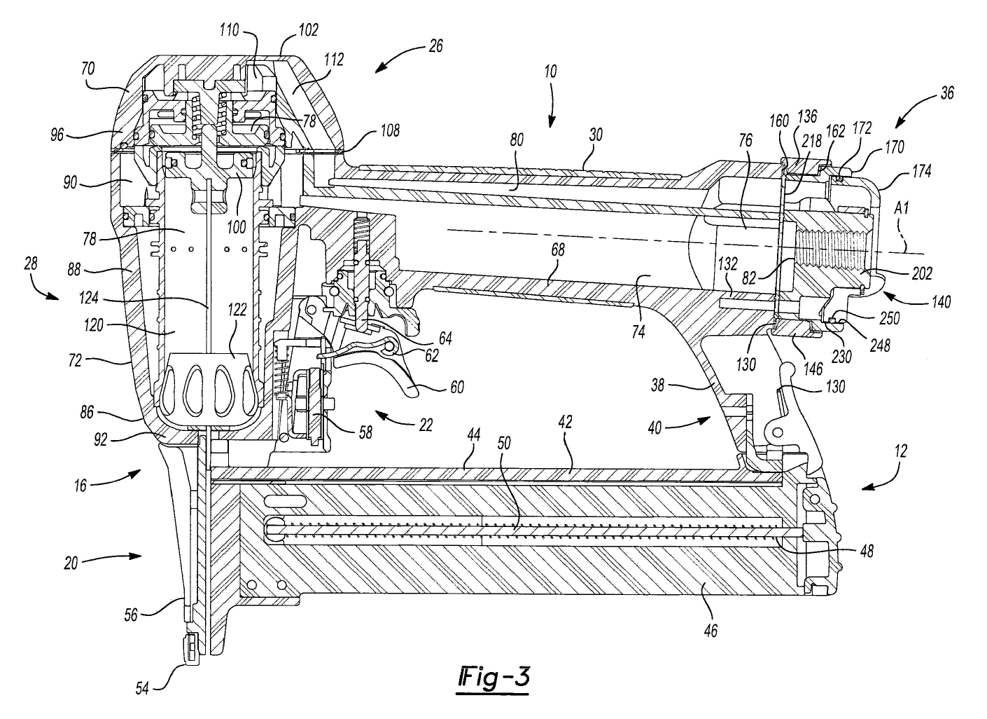

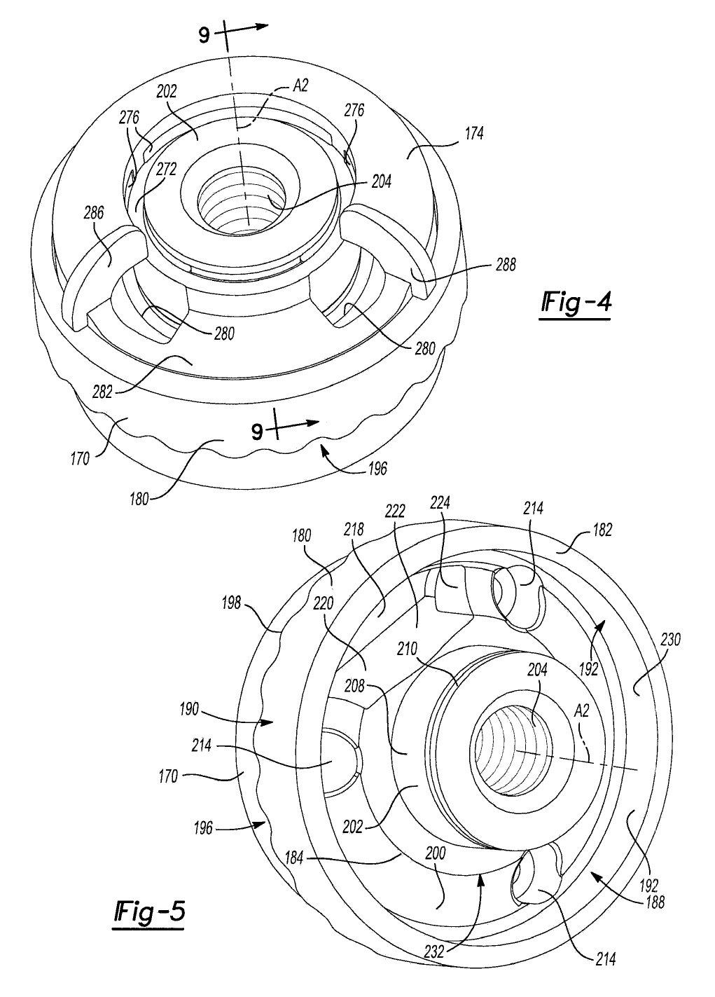

With particular reference now to FIGS. 4 and 5, the end cap 170 will be described in greater detail. The end cap 170 can define a cylindrical body portion 180 having a circumferential wall 182 and a central body 184. The cylindrical body portion 180 can include an upstream portion 186 (FIG. 2) and a downstream portion 188. The circumferential wall 182 can define outer and inner circumferential wall surfaces 190 and 192, respectively. The outer circumferential wall surface 190 can define a second interlocking geometry 196. In the example shown, the second interlocking geometry 196 includes a complementary wave-like wall 198.

With reference to FIGS. 2 and 5, it will be appreciated that the wave spring 130 urges the first interlocking geometry 166 of the belt hook 136 into cooperative engagement with the second interlocking geometry 196 of the end cap 170. As a result, relative axial movement (i.e. along axis A₁) between the belt hook 136 and the handle portion 68 of the tool 10 is limited. To adjust the rotational orientation of the belt hook 136, a user may urge the belt hook 136 axially toward the handle 68 to compress the wave spring 130. Such action allows the first and second interlocking geometries 166 and 196 to become offset. The user may then rotate the belt hook 136 to a desired rotational orientation. Once the orientation is attained, the user may release the belt hook 136 thereby allowing the wave spring 130 to return the respective interlocking geometries 166 and 196 into engagement. Alternatively, a user may apply sufficient torque to the belt hook 136 to cause the first interlocking geometry 166 to ride over the second interlocking geometry 196 and simultaneously compress the wave spring 130.

Returning to FIGS. 4 and 5, the central portion 184 of the end cap 170 can include an annular land 200 that can extend between the inner circumferential wall surface 192 and a boss 202. The boss 202 can define a central threaded passage 204 for accepting intake air from a pneumatic inlet fitting (not specifically shown). The central passage 204 defines an inlet axis A₂. In one example, the longitudinal axis A₁ (FIG. 3) may be collinear with the inlet axis A₂. An outboard portion 208 of the boss 202 may define an annular pocket 210 adapted to accept the retaining ring 176 (FIG. 2) in an installed position. A series of bores 214 may be formed through the annular land 200 for accommodating the fasteners 144 (FIG. 2) in the assembled position. The annular land 200 may define an end cap exhaust opening 218. The opening 218 may be defined by the inner circumferential wall surface 192 on the upstream portion 186 of the end cap 170 and a support wall 220 formed on the central portion 184. The support wall 220 may include a linear wall portion 222 and end wall portions 224 connecting the linear wall 222 portion to the inner circumferential wall surface 192. In one example, the end wall portions 224 may substantially conform to the contour of the bores 214 formed through the annular land 200.

As will be appreciated, the end cap exhaust opening 218 is configured to pass exhaust air from the upstream portion 186 (FIG. 2) to the downstream portion 188 of the end cap 170. As best illustrated in FIG. 3, the end cap exhaust opening 218 may be substantially aligned with the exhaust air portion 80 formed in the housing 30 in the assembled position.

Returning to FIG. 5, the inner circumferential wall surface 192 may define a first annular engagement surface 230 on the downstream portion 188. The boss 202 and the first annular engagement surface 230 can be generally opposed and can present an annular space 232 therebetween.

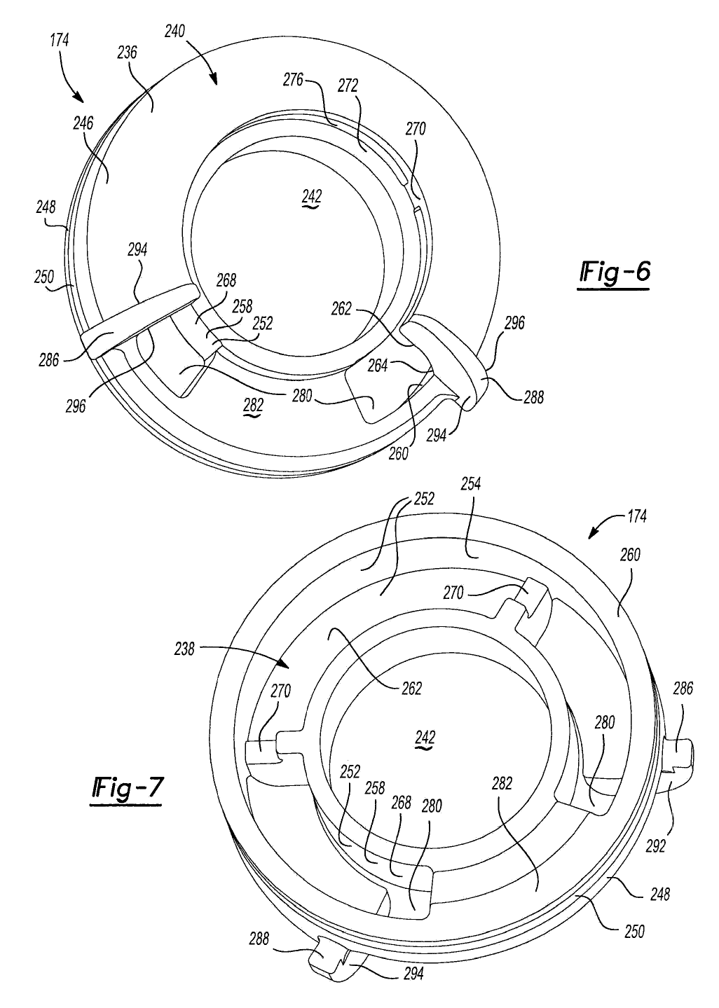

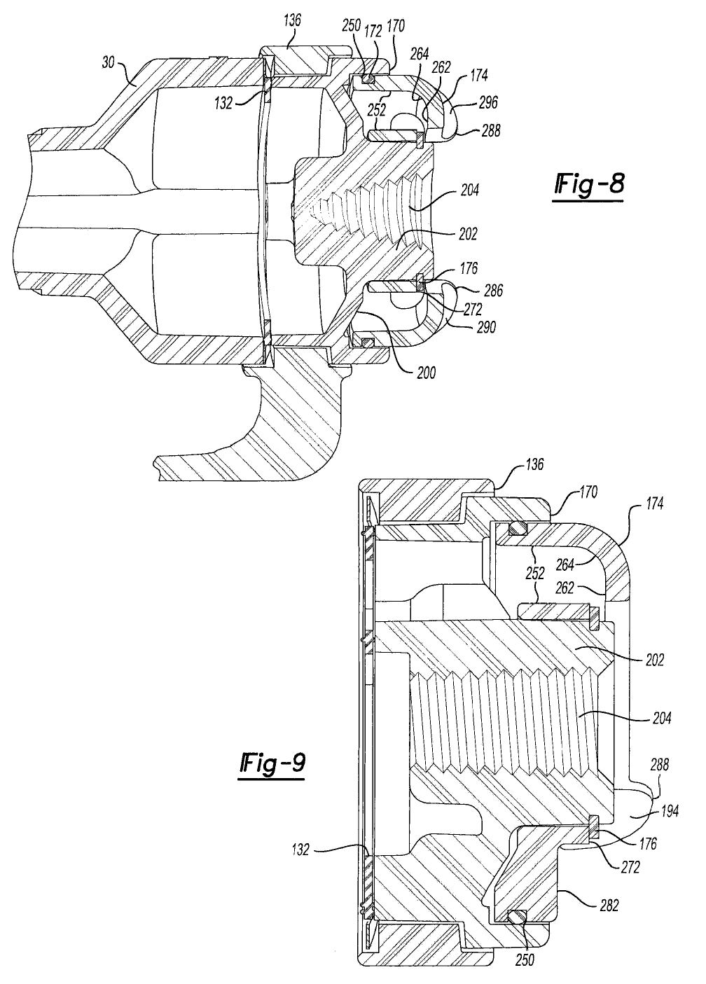

With continued reference to FIGS. 3 and 4 and additional reference to FIGS. 6 and 7, the exhaust deflector 174 will be described in greater detail. The exhaust deflector 174 can define a ring-like body portion 236 having an inboard side 238 (FIG. 7) and an outboard side 240 (FIG. 6). The ring-like body 236 can define a central opening 242 for accepting the boss 202 of the end cap 170 in an installed position. An outer wall 246 of the exhaust deflector 174 defines a second annular engagement surface 248 and an annular channel 250. The annular channel 250 is adapted to receive the friction member 172 (FIG. 3). In an installed position, the first annular engagement surface 230 of the end cap 170 opposes the second annular engagement surface 248 of the exhaust deflector 174. The friction member 172 may comprise an o-ring. The friction member 172 maintains an interface between the end cap 170 and the exhaust deflector 174 and facilitates smooth relative rotation of the exhaust deflector 174 about the end cap 170 as will be described in greater detail.

The inboard side 238 of the exhaust deflector can include an air directing surface 252. The air directing surface 252 may include an outboard air-deflecting wall portion 254 and an inboard air-deflecting wall portion 258. The outboard air-deflecting wall portion 254 may include an outer cylindrical wall portion 260, a terminal air-deflecting wall portion 262 and an intermediate radiused wall portion 264 interconnecting the outer cylindrical wall portion 260 and the terminal air-deflecting wall portion 262. The inboard air-deflecting wall portion 258 may include an inner cylindrical wall portion 268. A pair of ribs 270 can interconnect the outboard air-deflecting wall portion 254 and the inboard air-deflecting wall portion 258. The inboard wall portion 258 can define an outboard face 272 (FIG. 6) for engaging the retaining ring 176 in an installed position. A series of radial openings 276 can be defined adjacent the ribs 270.

A pair of exhaust outlets 280 may be defined through the ring-like body portion 236. In one example, the exhaust outlets 280 may be defined on a common quarter portion of the exhaust deflector 174. A planar pie-like connecting wall 282 can extend between the pair of outlets 280. The pie-like connecting wall 282 can define a plane substantially transverse to the inlet axis A₂ (FIG. 2). As best shown in FIG. 6, the pie-like connecting wall 282 may be formed inboard relative to the terminal air-deflecting wall 262. The exhaust outlets 280 may define passages generally through the transverse plane. As a result, the exhaust air is permitted to pass through the exhaust outlets 280 in a direction substantially parallel to the inlet axis A₂.

A pair of engagement tabs 286 and 288 can be formed at a transition between the exhaust outlets 280 and the terminal air-deflecting wall 262. The engagement tabs 286 and 288 each include opposite lateral walls 294 and 296 that can be spaced apart from one another in a desired manner. In one example, the spacing may decrease in a direction toward the central opening 242 so that the engagement tabs 286 and 288 are tapered. The engagement tabs 286 and 288 as a whole, and more specifically, the lateral walls 294, 296 of the engagement tabs 286 and 288 may generally extend on distinct planes that intersect the input axis A₂ (FIG. 5).

As described above, the connecting wall 282 may be formed inboard relative to the terminal air-deflecting wall 262. As a result, the lateral wall 294 of the engagement tab 288 can present a wide engaging face for a user's finger to impart counterclockwise motion (as viewed from FIG. 6) onto the exhaust deflector 174. Similarly, the lateral wall 296 of the engagement tab 286 presents a wide engaging face such as for a user's finger to impart clockwise motion (as viewed from FIG. 6) onto the exhaust deflector 174. It is appreciated that, while lateral walls 296 and 294 of the engagement tabs 288 and 286, respectively, are smaller, compared to their opposite lateral walls 294 and 296, force may also be imparted onto these walls to initiate rotational movement of the exhaust deflector 174.

With reference now to all FIG. 3, operation of the exhaust assembly 36 will be described in greater detail. Air communicated through the exhaust portion 80 of the air passageway 74 passes through the end cap passageway 218 and into the outboard portion 188 (FIG. 5) of the end cap 170. Once in the outboard portion 188 (FIG. 5) of the end cap 170, the air encounters the air directing surface 252 (FIG. 7) of the exhaust deflector 174 and is directed toward and through the outlets 280 (FIG. 7). It is appreciated that some of the exhausted air may escape through the openings 276 (FIG. 6) defined adjacent the ribs 270 (FIG. 6). To alter the position of the outlets 280 (FIG. 7), the user may rotate the exhaust deflector 174 to position the outlets 280 (FIG. 7) at various positions relative to the end cap 170. More specifically, the user may apply force onto the engagement tabs 286 (FIG. 7) and/or 288 (FIG. 7) for changing the rotational position of the exhaust deflector 174. Upon rotation of the exhaust deflector 174, the friction member 172 nested within channel 250 of the exhaust deflector 174 on the second annular engagement surface 248 slidably and sealingly engaged with the first annular engaged surface 230 of the end cap 170. The friction member 172 provides a seal between the respective engagement surfaces 230 and 248 and also provides constant user feedback around 360 degrees of exhaust deflector rotation.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A pneumatic fastening tool comprising:
a housing including a dispensing portion for dispensing a fastener;
a handle portion;
an inlet configured to receive input of compressed air; and
an exhaust assembly coupled to a distal end of the handle portion, the exhaust assembly comprising:
an end cap mounted to the housing and defining a first annular engagement surface;
a deflector rotatably mounted to the end cap and defining a second annular engagement surface, the deflector configured to direct exhausted air from the tool in a plurality of user defined directions depending on the rotational orientation of the deflector; and
a friction member disposed between the first and second annular engagement surfaces, the friction member providing a seal between the first and second annular engagement surfaces while also permitting rotation of the deflector relative to the end cap.

2. The pneumatic fastening tool of claim 1 wherein the housing defines an air passageway configured to communicate air from the inlet, to the fastening tool portion and out of the tool through the exhaust assembly.

3. The pneumatic fastening tool of claim 2 wherein the end cap defines an opening wherein air communicated through the exhaust assembly passes through the opening to the deflector.

4. The pneumatic fastening tool of claim 3 wherein the deflector defines an air directing surface configured to direct air being passed from the opening of the end cap and through at least one outlet formed in the deflector.

5. The pneumatic fastening tool of claim 4 wherein the air directing surface of the deflector includes a cylindrical air-deflecting wall portion offset radially inwardly relative to the first annular engagement surface of the end cap.

6. The pneumatic fastening tool of claim 5 wherein the air directing surface of the deflector further includes a terminal wall portion extending generally transverse to the cylindrical wall portion and an intermediate radiused wall portion connecting the cylindrical wall portion and the terminal wall portion.

7. The pneumatic fastening tool of claim 4 wherein the deflector includes a first engagement tab, wherein the deflector is configured to rotate about the first annular engagement surface upon a user input force applied to the first engagement tab.

8. The pneumatic fastening tool of claim 7 wherein the deflector includes a second engagement tab, wherein the first and second engagement tabs are each defined along a distinct plane intersecting a longitudinal axis defined by the inlet.

9. The pneumatic fastening tool of claim 8 wherein the at least one outlet includes a first outlet formed adjacent the first engagement tab and a second outlet formed adjacent to the second engagement tab.

10. The pneumatic fastening tool of claim 9 wherein the first and second outlet passages each define an opening configured to direct exhausted air in a direction parallel to the longitudinal axis.

11. The pneumatic fastening tool of claim 1 wherein the friction member comprises an o-ring.

12. The pneumatic fastening tool of claim 1 wherein the exhaust assembly further comprises a retaining ring disposed in an annular groove formed on the end cap, the retaining ring engaging a retaining surface defined on the exhaust and inhibiting axial movement of the exhaust relative to the end cap.

13. A pneumatic fastening tool comprising:
a housing including a dispensing portion for dispensing a fastener;
a handle portion defined on the housing;
an inlet configured to receive input of compressed air, the inlet defining an inlet axis, and
an exhaust assembly defined on a distal end of the handle portion, the exhaust assembly including a deflector rotatably mounted at the distal end of the handle portion and defining a first outlet, the deflector configured to direct exhausted air from the tool in a plurality of user defined directions depending on the rotational orientation of the deflector, wherein the first outlet is defined through a plane substantially transverse to the inlet axis.

14. The pneumatic fastening tool of claim 13 wherein the exhaust assembly further includes an end cap fixedly mounted to the housing and defining an opening and a first annular engagement surface.

15. The pneumatic fastening tool of claim 14, further comprising an o-ring disposed between the first annular engagement surface of the end cap and a second annular engagement surface defined on the deflector, wherein the o-ring is configured to provide a seal between the first and second annular engagement surfaces.

16. The pneumatic fastening tool of claim 15 wherein the deflector defines an air directing surface configured to direct air being passed from the opening of the end cap and through the outlet formed in the deflector.

17. The pneumatic fastening tool of claim 16 wherein the air directing surface of the deflector includes a cylindrical air-deflecting wall portion offset radially inwardly relative to the first annular engagement surface of the end cap.

18. The pneumatic fastening tool of claim 17 wherein the air directing surface of the deflector further includes a terminal wall portion extending generally transverse to the cylindrical wall portion and an intermediate radiused wall portion connecting the cylindrical wall portion and the terminal wall portion.

19. The pneumatic fastening tool of claim 18 wherein the deflector includes a first engagement tab, wherein the deflector is configured to rotate about the first annular engagement surface upon a user input force applied to the first engagement tab.

20. The pneumatic fastening tool of claim 19 wherein the deflector includes a second engagement tab, wherein the first and second engagement tabs are each defined along a distinct plane intersecting a longitudinal axis defined by the inlet.

21. The pneumatic fastening tool of claim 20, further comprising a second outlet formed adjacent to the second engagement tab.

22. The pneumatic fastening tool of claim 21 wherein the first and second outlet passages each define an opening configured to direct exhausted air in a direction parallel to the inlet axis.

23. A pneumatic fastening tool comprising:
an exhaust assembly coupled to a distal end of the tool, the exhaust assembly comprising:
an end cap mounted to the tool and defining and opening and a first annular engagement surface;
a deflector rotatably mounted to the end cap and defining a second annular engagement surface, the deflector configured to rotate about an axis and direct exhausted air from the tool in a plurality of user defined directions depending on the rotational orientation of the deflector, the deflector defining an air directing surface configured to direct air being passed from the opening of the end cap and through at least one outlet formed in the deflector, the at least one outlet configured to direct exhausted air in a direction parallel to the axis; and
a friction member disposed between the first and second annular engagement surfaces, the friction member providing a seal between the first and second annular engagement surfaces while also permitting rotation of the deflector relative to the end cap.
